(19) United States
(12) Patent Application Publication
(10) Pub. No.: US 2026/0368378 A1
(43) Pub. Date: Nov. 19, 2026

(54) POINT-BASED MESH GENERATION FOR COMPUTER-AIDED DESIGN (CAD) OBJECTS

(71) Applicant: Siemens Industry Software Inc., Plano, TX (US)

(72) Inventors: Nilanjan Mukherjee, Cincinnati, OH (US); Vasa Reddy, Milford, OH (US); Gregory Schlessman, Maineville, OH (US); Dhana Kandula, Cincinnati, OH (US)

(73) Assignee: Siemens Industry Software Inc., Plano, TX (US)

(21) Appl. No.: 19/475,653

(22) PCT Filed: Apr. 25, 2023
(86) PCT No.: PCT/US2023/019779

§ 371 Date: Oct. 15, 2025

(51) Int. Cl. G06F 30/12

(52) U.S. Cl. CPC G06F 30/12

(57) ABSTRACT

A computing system may include a point identification engine configured to identify a point on a computer-aided design (CAD) face of a CAD object and a point-based meshing engine configured to construct an imprint shape (530) that surrounds the identified point by performing an iterative imprint shape determination process. The point-based meshing engine may construct a candidate imprint shape for a given iteration, orient the candidate imprint shape, and perform an intersection check for the candidate imprint shape. When the intersection check indicates an intersection, the point-based meshing engine may determine a candidate imprint shape from a previous iteration as the imprint shape. The point-based meshing engine may also be configured to mesh the determined imprint shape that surrounds the identified point.

### BACKGROUND

Computer systems can be used to create, use, and manage data for products, items, and other objects. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design, visualization, and simulated testing of product structures and product manufacture.

### BRIEF DESCRIPTION OF THE DRAWINGS

Certain examples are described in the following detailed description and in reference to the drawings.

FIG. 1 shows an example of a computing system that supports point-based mesh generation.

FIG. 2 shows an example of point-based mesh generation according to the present disclosure.

FIG. 3 shows an example identification of a point on a CAD face by a point identification engine.

FIG. 4 shows an example of logic that computing system may implement to support point-based mesh generation.

FIG. 5 shows example iterations of an iterative imprint shape determination process that a point-based meshing engine may perform to a determine an imprint shape that surrounds an identified point.

FIG. 6 shows examples of point-based mesh generation according to the present disclosure.

FIG. 7 shows an example of a computing system that supports point-based mesh generation.

### DETAILED DESCRIPTION

With technological advancements in CAD computing systems, the capabilities of CAD-based design, simulation, and processing of 3D objects represented as CAD models are increasing as well. Complex simulations can be performed to test nearly any aspect, characteristic, or behavior of CAD objects that digitally model physical products. CAE systems may, for example, can provide finite element analysis (FEA)-based simulation suites that can implement complex and robust simulation features for a vast variety of tests on nearly any type of product. Example simulation scenarios supported by modern CAE systems range from thermal simulations of gas turbine components, to pressure measurements for composite ply-layup procedures, to complex fluid dynamics simulations, to detailed impact simulations of car parts in vehicular crashes, and many more.

FEA simulation suites typically rely on an underlying mesh to drive simulation capabilities. A mesh may be comprised of mesh elements that together cover the surface (or volume) of a CAD model, forming the mesh. Mesh elements may have various characteristics, shapes, and parameters, with specific mesh element attributes depending on the meshing process used to generate the mesh. For instance, mesh elements can be triangular, quadrilateral, or hexahedral in shape, as but a few examples. As used herein, meshing may refer to any process, procedure, computation, or flow that generates a mesh. Modern meshing technologies have continued to increase in complexity, and mesh model preparation processes have become increasingly specialized. Geometry preparation and simplification for meshing and mesh generation technologies have faced challenges with scalability and variability. In a similar manner that geometric representations cannot be over-simplified without impacting FEA simulation accuracy, a single surface meshing algorithm may be insufficient to satisfy analysis accuracy demands across a variety of types of object models and simulation scenarios.

Various types of structural analysis and other FEA simulations for 3D models require high-quality meshes to accurately analyze a CAD model. Mesh quality may be measured through any number of quantifiable measures, and any suitable measure of mesh quality is contemplated herein. As illustrative examples, CAD systems, FEA simulation systems, or other computing systems may quantify mesh quality based on the degree to which a mesh (or particular mesh region) is a structured mesh. A structured mesh may be measured by or otherwise refer to a mesh with less than a threshold number of singularities, and a singularity may refer to any vertex (or node) in the mesh with an irregular valency. The regular valency value for a given mesh may be set based on mesh type of the mesh or underlying mesh elements. For instance, a quadrilateral mesh with quadrilateral mesh elements may include have a regular valency of 4, and singularities occur if a vertex of the quadrilateral mesh is connected to less than or more than 4 quadrilateral mesh elements.

An ideal structured quadrilateral mesh may have all interior nodes that are tetra-valent (e.g., with a valency of 4), and such a mesh may have 0 singularities. The degree to which a given mesh or mesh region is structured may be quantified through classifications as “structured” or “fully structured” meshes (e.g., 0 singularities for mesh-interior nodes), “quasi-structured” meshes (e.g., a threshold number or percent of mesh-interior nodes have 0 singularities, such as 95+% 0-singularity mesh interior nodes), or “unstructured” meshes (e.g., a high number of mesh node singularities). The quality measure of structured/quasi-structured/unstructured mesh and mesh regions may be configurable to meet FEA-specific thresholds.

As another example quality measure, isotropy may provide a quantifiable gauge to evaluate meshes and underlying mesh regions. An isotropic mesh may refer to a mesh in which mesh elements differ in size (e.g., area) within a configurable size difference threshold. Having mesh elements that are similar in size may improve the effectiveness of FEA simulations. In some cases, isotropy measures may also require that edges of mesh elements be similar sized as well, e.g., differing only within a configurable edge difference threshold. Additionally or alternatively, isotropy measures may include singularity requirements as well for mesh interior nodes in order to classify a mesh as an isotropic mesh. On the other hand, anisotropic meshes may be classified when mesh elements differ in size beyond the size difference threshold, edges of mesh elements differ in length beyond the edge difference threshold, mesh element singularities exceed an acceptable threshold, or combinations thereof. Through mesh structure and isotropy quality measures, mesh quality can be objectively quantified in order to assess and evaluate meshing effectiveness.

As noted herein, high-quality meshes may be particularly relevant for effective FEA processes to evaluate product structures and behavior. As an example need for high-quality meshes (e.g., as measured through structure or isotropy), stress analyses in 3D models often analyze deflections, cracking, and stress points at specific (e.g., critical) regions of a 3D object, for example at holes, nut and bolt locations, sheet cut outs, etc. In some cases, high-quality meshing surrounding specific points of a CAD face are necessary for effective FEA simulations. For example, industrial finite element analysts often need to improve the quality of a mesh in areas of interest based on a first analysis of a 3D object. If a first analysis reveals higher stresses, deflections, or dynamic behaviors occur in areas where the mesh is not uniform or isotropic, the mesh in these areas need to be improved.

Having high quality mesh elements at specific points (and the mesh region surrounding these specific points) may be imperative to ensure proper structural analyses. In mesh regions of interest such as those with higher stress concentrations, severe structural shocks, dynamic responses, creep, etc., improvement of mesh quality at such points or regions of interest is crucial. Moreover, such points of interests are often hotspots for 3D object design and simulation.

Modern meshing techniques that mesh entire CAD faces or entire CAD objects may improve mesh quality in significant ways, though with limitations. Even in meshes generated via modern mesh generation technologies, unstructured or anisotropic mesh regions may still remain, which may be particularly troublesome for mesh hotspots that require special consideration in FEA simulations. Conventional techniques to improve mesh quality at specific points and mesh regions are limited in various ways. Finite element analysts or other users may manually modify an existing mesh to improve mesh quality at specific mesh regions. Individual users may manually delete existing mesh elements in an interest region and use a manual tool to re-mesh the local area. However, such manual processes can be tedious, time-consuming, and error prone. Another conventional process may be to re-mesh an area of interest with interior constraints, e.g., through manual insertion of construction lines that modify the geometry of a CAD face to re-mesh the area of interest. Again, such processes are manual, and may additionally incur performance increases due to geometry modifications of an underlying CAD object.

As another conventional technique, adaptive meshing can provide mesh refinement capabilities, including after an initial FEA simulation is performed. Such mesh refinement through adaptive meshing can target specific areas of interest identified by the FEA simulation and improve mesh quality. However, doing so through such adaptive meshing techniques is computationally intensive, requiring determination of error estimates, adjusting mesh element features based on determined error estimates and continually refining the mesh elements to reduce error estimates. Adaptive meshing techniques are often long, iterative remeshing processes that can require a high number of complete remeshing iterations of CAD faces until error estimates are within a tolerable range or other stopping criteria are reached. Multiple, iterative re-meshing of entire meshes can be computationally intensive, resource-expensive, and cause significant delays in finite element analyses of 3D objects.

The present disclosure may provide point-based mesh generation technology that can provide elegant, efficient, and flexible mechanisms to improve mesh quality in mesh regions surrounding any number of selected points of a mesh. In contrast to costly iterative re-meshing of adaptive techniques, the point-based mesh generation features of the present disclosure may provide a one-time direct solve, e.g., through a single re-mesh. Unlike manual processes to painstakingly re-mesh a mesh region, the point-based mesh generation technology of the present disclosure may algorithmically determine a relevant region surrounding a determined point, and re-mesh the relevant region through imprint-based mesh generation technology.

Various features of imprint-based mesh generation technologies are described in international patent application no. PCT/US2021/037651, titled “Imprint-Based Mesh Generation for Computer-Aided Design (CAD) Objects” and filed on Jun. 16, 2021 (“the '651 application”) as well as international patent application no. PCT/US2021/062588, titled “Constraint-Driven Imprint-Based Mesh Generation for Computer-Aided Design (CAD) Objects” and filed on Sep. 12, 2021 (“the '588 application”), the contents of each of which are incorporated herein by reference in their entirety. As described in the '651 application and '588 application, imprint-based meshing technology can provide capabilities to imprint virtual shapes on to faces of CAD models and treat such imprinted shapes as distinct meshing zones within the same CAD face.

By decomposing a single CAD face into multiple regions (e.g., multiple virtual faces), the imprint-based meshing technology of the '651 application and '588 application may support imprint-based meshing without altering the actual geometry of a CAD object, which may be especially effective as conventional geometric operations can incur significant computational costs as compared to local imprinting and zoning of CAD faces of the described imprint-based meshing technology. Moreover, imprint-based mesh generation may include capabilities to adjust mesh directions for specific mesh regions, supporting alignment of specific mesh regions based on the underlying mesh elements that the specific mesh regions overlay in a CAD face.

The present disclosure may likewise provide the imprint-based meshing capabilities described in the '651 application and '588 application, and thus likewise render the tangible technical improvements and technical benefits of imprint-based meshing as compared to conventional technologies. Moreover, the present disclosure may provide systems, methods, devices, and logic for point-based mesh generation. As described herein, mesh improvements may be flexibly performed based on specific points in a mesh, allowing for customizable and efficient re-meshing of areas of interest to support and generate meshes of increased structure and isotropy at particular mesh regions. In some implementations, a user may specify a point on a mesh, and the point-based mesh generation of the present disclosure may compute an imprint shape that surrounds the specified point to re-mesh the mesh region surrounding the specified point. In other implementations, the point-based mesh generation technology described herein may identify a point on a CAD face through analysis of the CAD face (e.g., as a centroid a largest area rectangle within the CAD face).

As another feature, the point-based mesh generation technology of the present disclosure may include features to iteratively generate candidate imprint shapes, orient the candidate imprint shapes, and evaluate the candidate imprint shapes to eventually determine the imprint shape that surrounds an identified point. In such an iterative manner, the point-based mesh generation technology may weight various factors in imprint shape construction, including size, orientation, and boundaries that surround a specified point (e.g., CAD face boundaries or boundaries of other shapes). Through such iterative imprint shape determination processes, the point-based mesh generation technology described herein may support flexible and efficient re-meshing of mesh regions that surround specified points on a CAD face.

These and other features of the point-based meshing technology and the technical benefits of the present disclosure are described in greater detail herein.

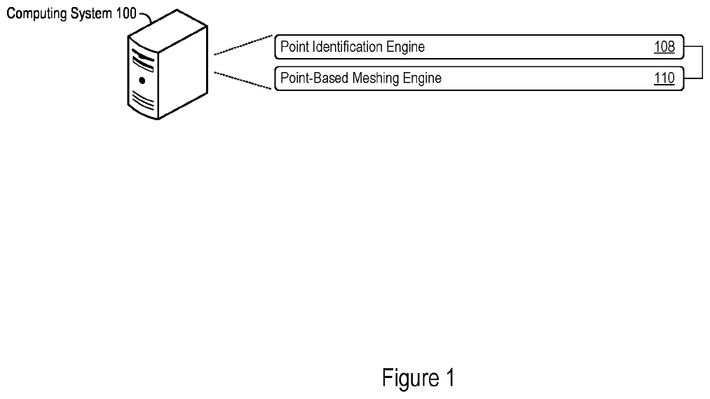

FIG. 1 shows an example of a computing system 100 that supports point-based mesh generation. The computing system 100 may take the form of a single or multiple computing devices such as application servers, compute nodes, desktop or laptop computers, smart phones or other mobile devices, tablet devices, embedded controllers, and more. In some implementations, the computing system 100 hosts, supports, executes, or implements a CAD application that provides any combination of mesh generation and processing capabilities, such as the point-based meshing technology of the present disclosure.

As an example implementation to support any combination of the point-based meshing features described herein, the computing system 100 shown in FIG. 1 includes a point identification engine 108 and a point-based meshing engine 110. The computing system 100 may implement the engines 108 and 110 (including components thereof) in various ways, for example as hardware and programming. The programming for the engines 108 and 110 may take the form of processor-executable instructions stored on a non-transitory machine-readable storage medium and the hardware for the engines 108 and 110 may include a processor to execute those instructions. A processor may take the form of single processor or multi-processor systems, and in some examples, the computing system 100 implements multiple engines using the same computing system features or hardware components (e.g., a common processor or a common storage medium).

In operation, the point identification engine 108 may identify a point on CAD face of a CAD object. The identified point may specify a mesh location on a mesh for the CAD face, such as a point-of-interest in the mesh. In operation, the point-based meshing engine 110 may construct an imprint shape that surrounds the identified point by performing an iterative imprint shape determination process. For a given iteration of the iterative imprint shape determination process, the point-based meshing engine 110 may construct a candidate imprint shape for the given iteration, orient the candidate imprint shape along a determined mesh element direction of background mesh elements of the CAD face covered by the candidate imprint shape, and perform an intersection check between the candidate imprint shape and a boundary set for the CAD face. The boundary set can boundaries of the CAD face or boundaries of other imprint shapes for the CAD face.

When the intersection check indicates the candidate imprint shape intersects a boundary in the boundary set for the CAD face, the point-based meshing engine 110 may determine a candidate imprint shape from a previous iteration of the iterative imprint shape determination process as the imprint shape that surrounds the identified point. In operation, the point-based meshing engine 110 may then mesh the determined imprint shape that surrounds the identified point.

These and other point-based meshing features and technical benefits are described in greater detail next. Many of the examples presented herein use point identification and shape imprinting on a 2D parameter space of a CAD face as an illustrative example (and 2D imprinting, decomposing, and/or meshing can then be transformed into a 3D model). However, the present disclosure is not so limited, and any of the point-based meshing technology may be consistently implemented directly for 3D faces of a CAD object.

The point-based meshing technology presented herein may be implemented as part of or local to the meshing capability of a CAD application, and as such may be implemented as part of the design and architecture of a meshing component of a CAD application to support point-based shape imprinting on CAD faces. In that regard, the point-based meshing technology may subdivide or partition a CAD face into multiple zones (also referred to as virtual faces) by imprinting shapes onto the CAD face that define the different regions to mesh in a CAD face. Determination of imprint shapes that surround specific points of a CAD face may provide a flexible and effective mechanism to improve mesh-quality at specific points-of-interest for a 3D object. Many examples of the present disclosure are presented using the point identification engine 108 and the point-based meshing engine 110 as illustrative implementations. However, any viable implementation of the point-based meshing technology is contemplated herein.

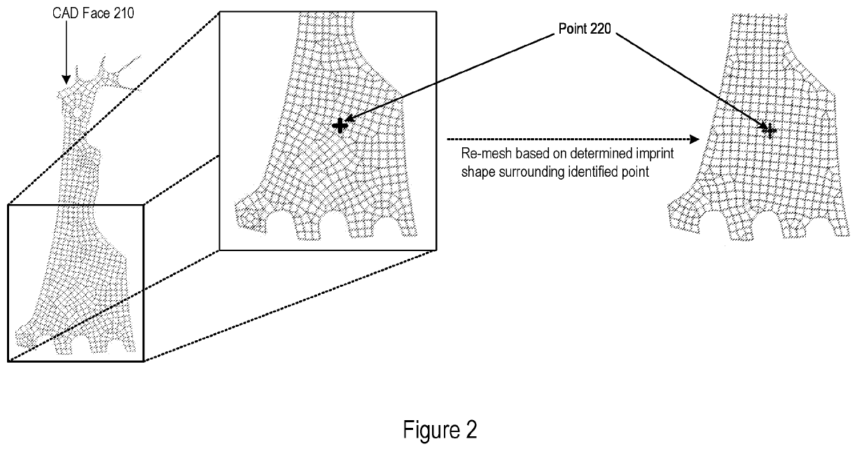

FIG. 2 shows an example of point-based mesh generation according to the present disclosure. In the example of FIG. 2, a CAD face 210 is shown. The CAD face 210 may be a part of a CAD object, and the CAD face 210 is shown in a 2D parameter space. A CAD system may access the CAD face 210 (e.g., via the point identification engine 108 or the point-based mesh engine 110) and may do so by flattening a 3D mesh of a CAD face into a 2D parameter space. In the illustrative example shown in FIG. 2, the CAD face 210 has an irregular shape, and may thus be more prone to mesh singularities, reduced mesh structure, or anisotropic characteristics. As such, various anisotropic interest regions or irregular mesh elements may be present in the mesh of the CAD face 210.

The point-based mesh generation technology of the present disclosure may support re-meshing of the CAD face 210 on a point-specific basis. In the example shown in a FIG. 2, a point 220 is depicted on the CAD face 210 through a “+” symbol. The point identification engine 108 may identify the point 220 on the CAD face 210, and the point-based mesh generation engine 110 may re-mesh a mesh region surrounding the identified point 220. In doing so, the point-based mesh generation engine 110 may determine an imprint shape that specifically surrounds the point 220 and mesh the determined imprint shape according to any suitable imprint-based mesh generation capability that the point-based mesh generation engine 110 may implement. In the example of FIG. 2, the re-meshed region surrounding the point 220 exhibits increased mesh structure and isotropy as compared to the original mesh of the CAD face 210. As such, various point-based mesh generation features presented herein may support a flexible and configurable mechanism to efficiently improve mesh quality at and surrounding specific points of a CAD face.

Various forms of point identification are contemplated herein, any of which the point identification engine 108 may implement to support the point-based mesh generation technology of the present disclosure. In some examples, the point identification engine 108 may identify the point 220 as a user-selected point on the CAD face 210, for example through the user interface of a CAD application. In that regard, the point identification engine 108 may provide point selection capabilities to specify the point 220 (e.g., via a mouse click, point selection tool, or in any other suitable manner). User-selected point selection may provide increased user control, flexibility, and capability in controlling how meshing is performed for a given mesh. The point identification engine 108 may allow finite element analysts (or any other users) to select specific mesh points of a given mesh for which to improve mesh quality around.

Such user-selection features may provide improved user efficiency in how a particular mesh is processed, especially as finite element analysts or other users may require mesh quality improvements in specific mesh areas or regions-of-interest critical to FEA simulations and the like. Then, the point-based meshing technology described herein may automatically mesh (e.g., re-mesh) the mesh region surrounding the user-selected point, doing so in any of ways described herein. Automatic meshing may be performed without further user input or intervention, supporting a one-click solution by which selected points (and surrounding mesh regions) can be re-meshed to improve mesh quality. In other examples, the point-based meshing technology may support providing user confirmation capabilities to allow an FE analyst or other user to preview the meshed regions and confirm the change before effectuating the re-mesh for a given CAD face or mesh representation.

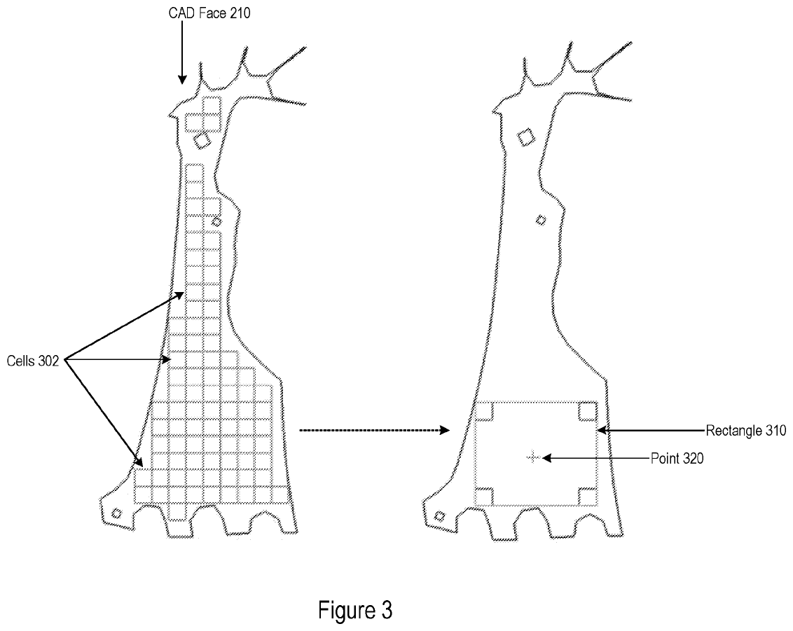

In some examples, the point identification engine 108 may process the CAD face 210 to determine the point 220 without user intervention. The point identification engine 108 may apply any number of combination of criteria, techniques, or factors by which to identify points (and surrounding mesh regions) in the CAD face 210 for which to improve mesh quality. Automatic determination of re-mesh points for a CAD face may be performed by the point identification engine 108 through determination of an axis-aligned rectangle of largest area inscribed within the CAD face boundary. An example of point determination by the point identification engine 108 is described next with reference to FIG. 3.

FIG. 3 shows an example identification of a point on a CAD face by the point identification engine 108. As used herein, identification of a point on CAD face can refer to point identification on the geometry of the CAD face itself or point identification on a mesh representation of the CAD face. As noted herein, the point identification engine 108 may automatically identify a point on a CAD face without user selection and may do so based on rectangles inscribed within the polygon boundary of the CAD face. In some implementations, the point identification engine 108 may determine points for point-based mesh generation based on rectangle(s) with a largest area in the CAD face, such as a centroid (or other determined location) of a determined largest area rectangle for the CAD face. Any suitable technique to determine a largest area rectangle within the CAD face may be implemented, used, or otherwise applied by the point identification engine 108. Largest area rectangle determinations may account for threshold distance requirements from CAD face boundaries (e.g., largest area rectangle at least a mesh element width or length from any CAD face boundaries of a CAD face).

In some examples, the point identification engine 108 may determine one or more axis-aligned largest area rectangles within the CAD face boundary, for example through a greedy algorithm. In doing so, the point identification engine 108 may discretize boundaries the CAD face (including face interior loops or boundaries) into points within the 2D parameter space. Then, the point identification engine 110 may partition the 2D parameter space representation of the CAD face into cells. The partitioned cells may be in the form of squares (or rectangles) of any configurable dimension, size, orientation, and the like. The point identification engine 108 may discard, remove, drop, or otherwise disregard any cell that is outside the CAD face or includes (e.g., overlaps) a CAD face boundary (or any point within the threshold distance requirement), which may include face interior boundaries such as holes, etc. Thus, the remaining non-discarded cells may be face interior cells of the CAD face.

In the example of FIG. 3, face interior cells 302 are shown within the CAD face 210 that the point identification engine 108 may construct for automatic point determination. In some implementations, the face interior cells 302 may be the subset of cells partitioned for the CAD face 210 that are at least a threshold distance from any boundary of the CAD face 210. From the cells 302, the point identification engine 108 may determine a largest area rectangle for the CAD face 210. To do so, the point identification engine 108 may implement a cell ranking mechanism that computes a cell rank for each of the face interior cells 302 of the CAD face 210. In some examples, the point identification engine 108 may compute the cell rank for a given cell through diagonal traversal of neighboring cells within the CAD face. The number of continuous row-wise neighbors for the given cell may be referred to as Uₛₚₐₙ and the number of continuous vertical neighbors of the given cell may be referred to as Vₛₚₐₙ. Determination of the Uₛₚₐₙ and Vₛₚₐₙ values for the given cell may be computed through the aforementioned diagonal traversal of neighboring cells, e.g., counting cells through diagonal traverse horizontally and vertically.

To illustrate, the diagonal traversal may be performed by the point identification engine in a right horizontal direction and upwards vertical direction. In such an illustration for a given cell, the point identification engine 108 may first determine if a diagonal face interior cell from the given cell exists in the upward and rightward direction. If so, the point identification engine 108 may determine if this face interior diagonal cell has continuous neighboring cells horizontally (leftward) to horizontally align with the given cell, e.g., continuous horizontal neighboring cells (leftward) to align with a vertical column/axis that includes the given cell. In a consistent manner, the point identification engine 110 may likewise determine whether the face interior diagonal cell has continuous neighboring cells vertically (downward) to vertically align with given cell, e.g., continuous vertical neighbor cells (downward) to align with a horizontal axis/column that includes the given cell. If so, the point identification engine 108 may increment the Uₛₚₐₙ and Vₛₚₐₙ values by one, and diagonal traversal may continue. The point identification engine 108 may thus count cells in an upward and rightward manner in computing a cell rank value for the given cell.

If a face interior diagonal cell does not have continuous vertical neighbors to align with the given cell, then Vₛₚₐₙ counting in the vertical direction stops, and cell traversal continues only horizontally instead of diagonally (or traversal for the given cell stops altogether if horizontal counting previously or concurrently stopped). If a face interior diagonal cell does not have continuous horizontal neighbors to align with the given cell, then Uₛₚₐₙ counting in the horizontal direction stops (or traversal for the given cell stops altogether if vertical counting previously or concurrently stopped). The point identification may thus traverse face interior cells for computation of a cell rank value of a given cell and compute Uₛₚₐₙ and Vₛₚₐₙ values for the given cell accordingly through cell traversal. The cell rank value for cells of the CAD face may be referred to as UVₛₚₐₙ, which the point identification engine 108 may compute as a product of the determined Uₛₚₐₙ and Vₛₚₐₙ values for each respective cell.

Then, the point identification engine 108 may determine the largest area rectangle through the cell with the highest UVₛₚₐₙ value. This cell with the highest UVₛₚₐₙ value may be the left bottom corner cell of the largest area rectangle. The cell that is diagonal to the left bottom corner cell on a span of Uₛₚₐₙ number of cells away horizontally and Vₛₚₐₙ number of cells away vertically is the top right corner cell of the largest area rectangle. Any face interior cells within the rectangle formed by the left bottom corner cell and the top right corner cell are cells of the largest area rectangle within the CAD face. Thus, the point identification engine 108 may determine a largest area rectangle for the CAD face and identify a point for re-meshing as the centroid of the determined largest area rectangle. In the example of FIG. 3, the point identification engine 108 determines the rectangle 310 as the largest area rectangle for the CAD face 210, e.g., as determined from the face interior cells 302. Then, the point identification engine 108 may identify the point 320 from the rectangle 310, e.g., through determination of the centroid of the rectangle 310.

In some implementations, the point identification engine 108 may identify multiple largest area rectangles for the CAD face through a greedy algorithm. To do so, the point identification engine 108 may iteratively compute cell rankings across the face interior cells of the CAD face, but dropping any face interior cells of the largest area rectangle computed in a previous iteration. Thus, the next iteration of the largest area rectangle determination may be performed without (e.g., disregarding) the cells of the largest area rectangle determined for the previous iteration. To illustrate through FIG. 3, the point identification engine 108 may determine another largest area triangle from the face interior cells 302, but do so by dropping/discarding the cells in the rectangle 310 prior to computing cell rank values for this other largest area triangle (and identified point within this other largest area triangle). In such a way, the point identification engine 108 may compute multiple largest area rectangles for a CAD face and determine multiple re-mesh points as well.

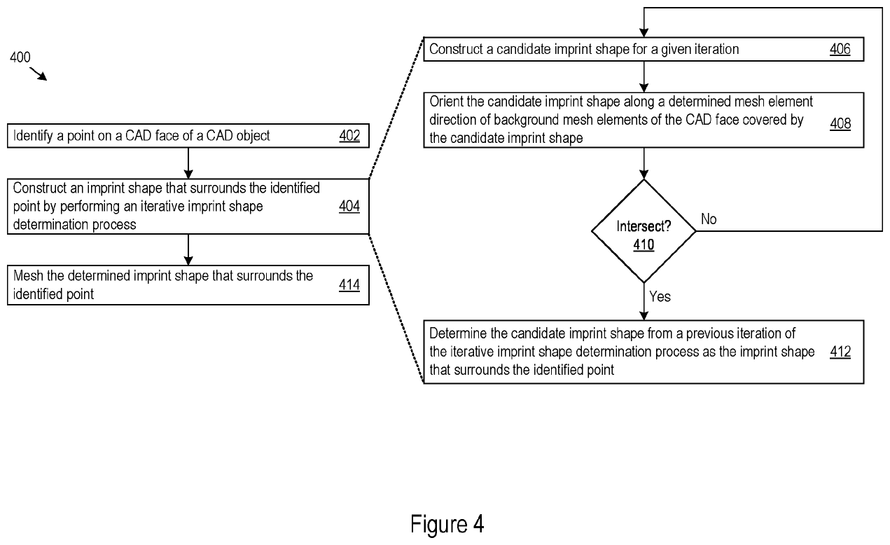

After point identification, the point-based mesh generation features of the present disclosure may re-mesh a mesh region surrounding an identified point. Doing so may comprise determination of an imprint shape that surrounds the identified point. Example features for imprint shape determination for identified points is described next, including with reference to FIG. 4.

FIG. 4 shows an example of logic 400 that a system may implement to support point-based mesh generation. For example, the computing system 100 may implement the logic 400 as hardware, executable instructions stored on a machine-readable medium, or as a combination of both. The computing system 100 may implement the logic 400 via the point identification engine 108 and the point-based meshing engine 110, through which the computing system 100 may perform or execute the logic 400 as a method to provide any combination of the imprint-based meshing features presented herein. The following description of the logic 400 is provided using the point identification engine 108 and the point-based meshing engine 110 as examples. However, various other implementation options by computing systems are possible.

In implementing the logic 400, the point identification engine 108 may identify a point on a CAD face of a CAD object (402), doing so in any of the ways described herein. As such, the point identification engine 108 may identify the point as a user-selected point on the CAD face. Additionally or alternatively, the point identification engine 108 may identify the point on the CAD face by determining a rectangle with a largest area (also referred to as large area rectangle) that fits in the CAD face (or within a threshold distance from boundaries of the CAD face, including face interior boundaries) and determining the point as a centroid of the rectangle with the largest area that fits in the CAD face.

For each point identified by the point identification engine 108, the point-based meshing engine 110 may re-mesh a mesh region that surrounds the identified point. In support of such point-based re-meshing and in implementing the logic 400, the point-based meshing engine 110 may construct an imprint shape that surrounds the identified point by performing an iterative imprint shape determination process (404). The iterative imprint shape determination process performed by the point-based mesh engine 110 may result in generation of an oriented imprint shape that surrounds an identified point, which can then support imprint-based meshing of the generated imprint shape.

In some implementations, the point-based meshing engine 110 may access multiple inputs for the iterative imprint shape determination process. As one example, inputs may include a CAD face (e.g., flattened into a 2D parameter space), mesh definition parameters (e.g., global element size, mesh element type, etc.), point location on the CAD face (e.g., as a 2D coordinate), imprint shape parameters (e.g., dimensions, shape, etc.), or any combination thereof. For the iterative imprint shape determination process, the point-based meshing engine 110 may generate, orient, and evaluate candidate imprint shapes that surround an identified point. In each iteration, the point-based meshing engine 110 may construct a progressively larger candidate imprint shape, orient the candidate imprint shape, and evaluate whether the oriented candidate imprint shape intersects with any boundaries for the CAD face.

To explain further through FIG. 4, in a given iteration, the point-based meshing engine 110 may construct a candidate imprint shape for the given iteration (406). In doing so, the point-based meshing engine 110 may generate an imprint shape that surrounds the identified point that can potentially serve as an imprint region/virtual face for which to re-mesh the CAD face. For improving local mesh quality, quadrilateral meshes may benefit particularly from orthogonal face-interior features or imprint regions. As such, the point-based meshing engine 110 may generate candidate imprint shapes with rectangular shapes in some implementations. However, candidate imprint shape generation of any suitable type is contemplated herein.

The point-based meshing engine 110 may determine dimensions for candidate imprint shapes in various ways. In some implementations, the point-based meshing engine 110 may construct a candidate imprint shape as a rectangular imprint shape with a dimension ratio (e.g., length-to-width ratio) equal to that of a largest area rectangle from which an identified point is determined by the point identification engine 108. As additional or alternative feature, the point-based meshing engine 110 may determine dimension ratios for candidate imprint shapes based on (e.g., consistent with or equal to) a mesh element size, width, or length, or in any other suitable manner. As yet another example, the dimension ratio may be set as an input parameter (e.g., expressly as a ratio value or as an imprintable shape template or base unit from which a dimension ratio can be determined).

For an initial iteration, the point-based meshing engine 110 may construct a candidate imprint shape of a predetermined size. For example, point-based meshing engine 110 may construct the initial candidate imprint shape from four (4) imprint shape elements, which may be elements with a dimension ratio of an imprintable rectangle and with a length or width equal to a mesh element size, a global element size, or any other configurable size parameter. This initial candidate imprint shape may be formed by the point-based meshing engine 110 as a 2×2 rectangle of imprint shape elements (e.g., base units) centered around an identified point. For subsequent iterations, the point-based meshing engine 110 may construct the candidate imprint shape by expanding the candidate imprint shape of the previous iteration of the iterative imprint shape determination process. Expansion may be through additional imprint mesh elements added horizontally and vertically to the candidate imprint shape of a prior iteration. Accordingly, for a second iteration of the iterative imprint shape determination process, the point-based meshing engine 110 may construct a 3×3 rectangle of imprint shape elements centered around an identified point. For a third iteration, the point-based meshing engine 110 may construct a 4×4 rectangle of imprint shape elements centered around an identified point, and so forth.

In a given iteration of iterative imprint shape determination process, the point-based meshing engine 110 may orient the candidate imprint shape, such as along a determined mesh element direction of background mesh elements of the CAD face covered by the candidate imprint shape (408). Various orienting and mesh direction feature are described in the '588 application, any of which the point-based meshing engine 110 may implement, access, or apply to orient a candidate imprint shape. For instance, the point-based meshing engine 110 may construct a background mesh for a CAD face and utilize frame field vectors to determine mesh element directions, e.g., as described in the '588 application. For the candidate imprint shape of a given iteration, the point-based meshing engine 110 may determine a mesh element direction for the candidate imprint shape based on the background mesh elements that the candidate imprint shape covers or overlays for the CAD face, e.g., as an average of the mesh element directions of the four (4) background mesh elements that the corners of the candidate imprint shape correspond to (e.g., overlay or are on top of in terms of position/coordinates/location in the CAD face).

To provide such orientation features, the point-based meshing engine 110 may perform any number of support operations prior to starting the first iteration of the iterative imprint shape determination process. For instance, the point-based meshing engine 110 may construct the background mesh, generate frame field vectors, move frame field vectors to mesh element corners, or any other suitable operation to support imprint shape orientation capabilities, including according to any of the ways described in the '588 application. In some implementations, the point-based meshing engine 110 may utilize a voxel grid to track points in the background mesh. Tracking points on the background mesh may allow the point-based meshing engine 110 to determine which background mesh elements correspond to the corner points of a candidate imprint shape.

A voxel grid comprised of nonconforming voxel cells may provide a fast-searching mechanism for point tracking. The point-based meshing engine 110 need not perform any numerical computation to find the corresponding voxel cell for each background mesh element. Each mesh element of the background mesh may correspond to a unique nonconforming voxel cell (NVC) of the voxel grid, and the point-based meshing engine 110 may generate each nonconforming voxel cell from its corresponding background mesh element (e.g., the voxel formed by the corner coordinates of the corresponding background mesh element). The point-based meshing engine 110 may store each voxel cell through its corner coordinates, e.g., expressed as:

$${NVC}_{i} ≡ [ \frac{{X}_{imin} , {X}_{imax}}{{Y}_{imin} , {Y}_{imax}} ]$$

In the expression above, NVC; denotes the i^{th} nonconforming voxel cell of the voxel grid and (Xᵢₘᵢₙ, Xᵢₘₐₓ, Yᵢₘᵢₙ, Yᵢₘₐₓ) denote the extremum coordinates of the i^{th} nonconforming voxel cell.

In order to locate a point P(x,y) (e.g., a corner point of a candidate imprint shape), the point-based meshing engine 110 need only compare the limiting values of each nonconforming voxel cell. The satisfying condition for P(x,y) to be inside the i^{th} nonconforming voxel cell is given by the following paired inequality:

Xᵢₘᵢₙ≤Pₓ≤Xᵢₘₐₓ

Yᵢₘᵢₙ≤P_{y}≤Yᵢₘₐₓ

As voxels within the voxel grid are nonconforming, a point may be shared by (e.g., located within the extremum coordinates of) more than one nonconforming voxel cell. If a point is shared by two or more voxel cells, then the point-based meshing engine 110 may perform a point-in-polygon check to determine which one of the overlapping voxel cells contains the point. The point-in-polygon test can also employ a vertical line drop method which only counts intersections by coordinate comparison and does not use any computation. As such, the point-based meshing engine 110 may construct and utilize a voxel grid to efficiently determine which background mesh element that portions (e.g., corners) of a candidate imprint shape correspond to (from which a frame field vector can be accessed for mesh element direction determination to orient the candidate imprint shape).

After orienting the candidate imprint shape in a given iteration, the point-based meshing engine 110 may perform an intersection check for the candidate imprint shape and the CAD face (410). In particular, the point-based meshing engine 110 may perform the intersection check between the candidate imprint shape for the given iteration and a boundary set for the CAD face. The boundary set may include the boundaries of the CAD face itself (including face interior boundaries) and boundaries of different imprint shapes for the CAD face. Thus, the point-based meshing engine 110 may determine if the candidate imprint shape interests with any boundary of the CAD face or any boundary of a different imprint shape for the CAD face.

Any suitable intersection checking techniques are contemplated herein, including accounting for distance thresholds from boundaries in the boundary set. In some implementations, the point-based meshing engine 110 may perform the intersection check by determining whether the candidate imprint shape is within a threshold distance from any boundary in the boundary set. The threshold distance may be set by the point-based meshing engine 110 as a mesh element length (e.g., as a global element size parameter or as a function thereof).

When the intersection check indicates the candidate imprint shape intersects a boundary in the boundary set for the CAD face, this may indicate that the candidate imprint shape (expanded from the candidate imprint shape from the previous iteration) is too large. Intersection with boundaries of other imprint shapes or a CAD boundary may indicate the candidate imprint shape would not be viable to imprint since its boundaries would exceed that of the CAD face itself or another imprint shape. Distance thresholds (e.g., of a global element size) may provide leeway for other meshing techniques. Paver meshing techniques may be desirable for mesh elements on CAD face boundaries, and thus the distance threshold in intersection checks may ensure that the candidate imprint shape does not interest a paver mesh element for the CAD face boundary. Accordingly, the intersection check may serve as a stopping criterion for the iterative imprint shape determination process.

Responsive to a determination that the candidate imprint shape of a given iteration intersects a boundary in the boundary set, the point-based meshing engine 110 may determine a candidate imprint shape from a previous iteration of the iterative imprint shape determination process as the imprint shape that surrounds the identified point (412). Such a determination may indicate an end to the iterative imprint shape determination process, for which the candidate imprint shape from the (immediately) previous iteration can be output as the constructed imprint shape that surrounds the identified point. When the intersection check indicates the candidate imprint shape of a given iteration does not intersect any boundary in the boundary set, the point-based meshing engine 110 may proceed to a next iteration of the iterative imprint shape determination process, e.g., by next constructing the candidate imprint shape for the next iteration by expanding the candidate imprint shape of the given iteration.

As described herein, the point-based meshing engine 110 may construct an imprint shape that surrounds an identified point of a CAD face. The constructed imprint shape may be oriented, in any of the ways described herein, and serve as an imprint region/virtual face by which meshing techniques can be applied to mesh (e.g., re-mesh) a region surrounding the identified point. As such, the point-based meshing engine 110 may mesh the determined imprint shape that surrounds the identified point (414). In some implementations, the point-based meshing engine 110 may mesh the determined imprint shape automatically, e.g., without further user intervention after a user selects a point for which to re-mesh an existing CAD face mesh. For example, the point-based meshing engine 110 may support one-click meshing of a given point by meshing (e.g., re-meshing) the mesh region that surrounds the user-selected point, doing so in any of the ways described herein. In some flows, the point-based meshing engine 110 may provide a preview option of a re-meshed region using the determined imprint shape, which may allow a user to confirm whether to effectuate the re-mesh for a given CAD face or revert to the original mesh.

In meshing the determined imprint shape, the point-based meshing engine 110 may apply any combination of the imprint-based meshing technology described in the '651 application and '588 application. For instance, the point-based meshing engine 110 may use virtual topology operators to construct a virtual face for the determined imprint shape and the virtual face may form an inner loop of a boolean/remainder virtual face. The point-based meshing engine 110 may mesh each virtual face separately, thus meshing the mesh region defined by the imprint shape surrounding the identified point to yield meshing of increased structure, isotropy, and overall quality.

The logic 400 shown in FIG. 4 provides an illustrative example by which a computing system 100 may support point-based meshing according to the present disclosure. Additional or alternative steps in the logic 400 are contemplated herein, including according to any of the various features described herein for the point identification engine 108, the point-based meshing engine 110, or any combinations thereof.

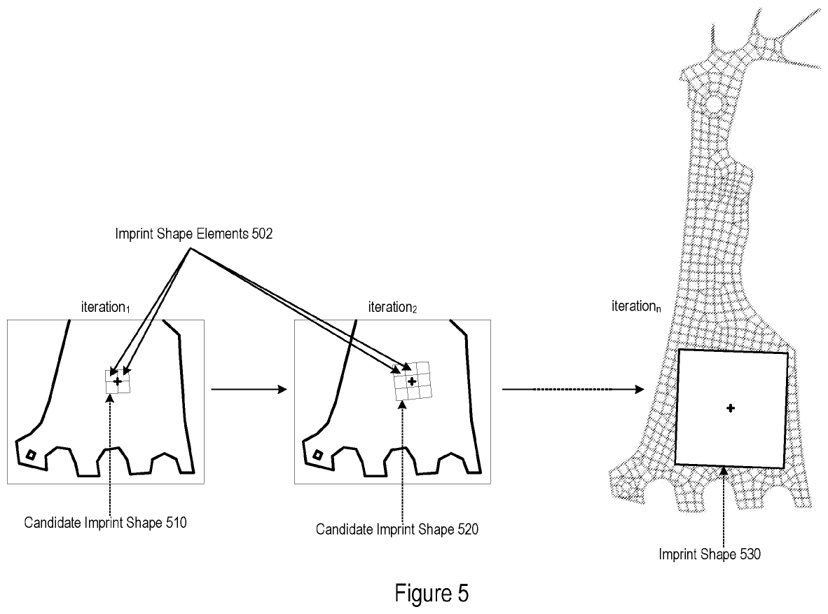

FIG. 5 shows example iterations of an iterative imprint shape determination process that the point-based meshing engine 110 may perform to a determine an imprint shape that surrounds an identified point. In FIG. 5, the identified point is denoted through a “+” symbol. To provide an illustrative example of iterative features of the iterative imprint shape determination process, FIG. 5 illustrates various iterations in the process, including those shown as iteration₁, iteration₂, and iterationₙ.

In a first iteration shown as iteration₁ in FIG. 5, the point-based meshing engine 110 may construct a candidate imprint shape from imprint shape elements. In particular, the point-based meshing engine 110 generates a 2×2 rectangle shape comprised of four (4) imprint shape elements 502, which together form the candidate imprint shape 510 of iteration₁. The constructed candidate imprint shape for iteration₁ surrounds (e.g., is centered on) the point labeled through the “+” symbol. The point-based meshing engine 110 may orient the candidate imprint shape 510 along a mesh element direction as determined through background mesh elements that the candidate imprint shape 510 (e.g., corners) correspond to. In iteration₁, the point-based meshing engine 110 may perform an intersection check between the candidate imprint shape 510 (oriented) and boundaries of a boundary set of a CAD face and determine that the candidate imprint shape 510 does not intersect and boundaries. Thus, the point-based meshing engine 110 may proceed to iteration₂ of the iterative imprint shape determination process.

In iteration₂ of the iterative imprint shape determination process, the point-based meshing engine 110 may construct a candidate imprint shape for by expanding the candidate imprint shape 510 of iteration₁. In the example of FIG. 5, the point-based meshing engine 110 constructs and orients the candidate imprint shape 520 as a 3×3 rectangle shape comprised of nine (9) imprint shape elements 502 that surrounds the identified point labeled through the “+” symbol. In some implementations, the point-based meshing engine 110 generates the candidate imprint shape of a given iteration as aligned along axes of the 2D parameter space (e.g., aligned along the X and Y axes of a 2D parameter space). In other implementations, the point-based meshing engine 110 generates the candidate imprint shape of a given iteration in the same orientation as the candidate imprint shape of the prior iteration. Continuing the example shown in FIG. 5, the point-based meshing engine 110 may orient the candidate imprint shape 520 for iteration₂ and perform an intersection check between the oriented candidate imprint shape 520 and boundaries of the boundary set.

In such a manner, the point-based meshing engine 110 may continue performing iterations of the iterative imprint shape determination process until a stopping criterion is reached. Such a stopping criterion is reached in iterationₙ of the iterative imprint shape determination process. In iterationₙ, the point-based meshing engine 110 may determine that the oriented candidate imprint shape constructed for iterationₙ intersects with a boundary in the boundary set of the CAD face. As such, the point-based meshing engine 110 may determine the candidate imprint shape constructed and oriented for the previous iteration (e.g., iterationₙ₋₁) as the imprint shape that surrounds the identified point. The determined imprint shape for the example iterative imprint shape determination process of FIG. 5 is shown as the imprint shape 530. The imprint shape 530 is determined by the point-based meshing engine 110 in iteration, of the iterative imprint shape determination process and may thus be the candidate imprint shape constructed and oriented for iterationₙ₋₁ of the iterative imprint shape determination process.

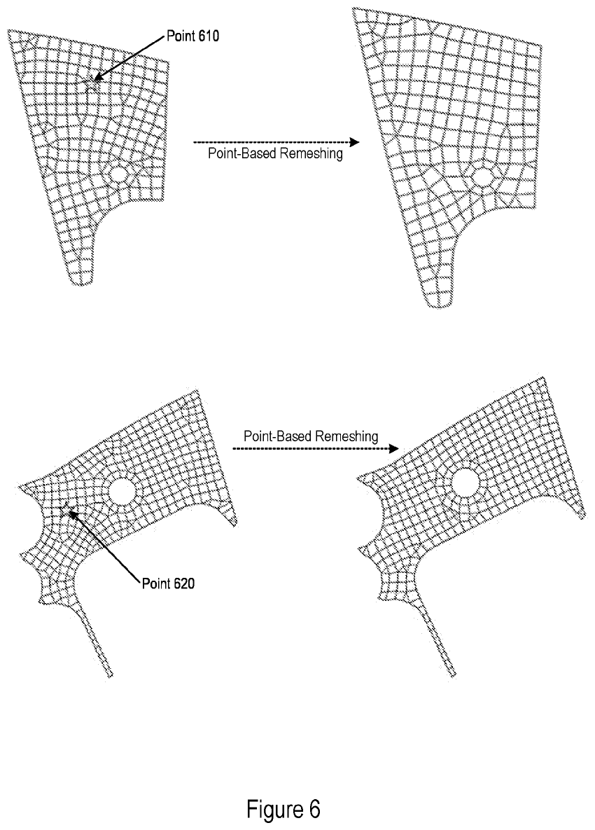

FIG. 6 shows examples of point-based mesh generation according to the present disclosure. In the example of FIG. 6, two CAD faces are shown in a mesh representation with point 610 identified in top CAD face and point 620 identified in the bottom CAD face. The point-based mesh generation technology the present disclosure may provide point-based meshing for each of these CAD faces, as shown in FIG. 6. The re-meshed CAD faces have increased structure, isotropy, and quality in the mesh regions that surround the points 610 and 620 respectively. These are just two examples of how the point-based mesh generation features described herein can provide flexible, efficient, and elegant technical capabilities to re-mesh portions of a mesh based on identified points.

While many point-based mesh generation features have been described herein through illustrative examples presented through various figures, the point identification engine 108 or the point-based meshing engine 110 may implement any combination of the point-based meshing technology described herein and including any imprint-based meshing features of the '651 application and the '588 application.

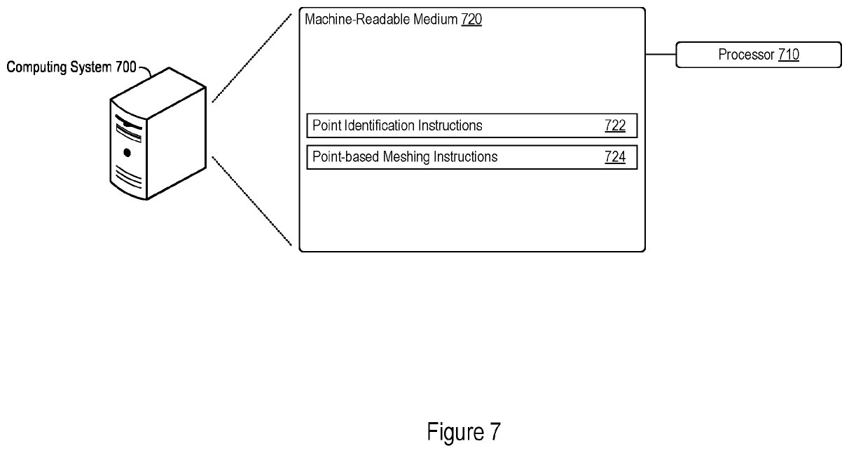

FIG. 7 shows an example of a computing system 700 that supports point-based mesh generation. The computing system 700 may include a processor 710, which may take the form of a single or multiple processors. The processor(s) 710 may include a central processing unit (CPU), microprocessor, or any hardware device suitable for executing instructions stored on a machine-readable medium. The computing system 700 may include a machine-readable medium 720. The machine-readable medium 720 may take the form of any non-transitory electronic, magnetic, optical, or other physical storage device that stores executable instructions, such as the point identification instructions 722 and the point-based meshing instructions 724 shown in FIG. 7. As such, the machine-readable medium 720 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 700 may execute instructions stored on the machine-readable medium 720 through the processor 710. Executing the instructions (e.g., the point identification instructions 722 and/or the point-based meshing instructions 724) may cause the computing system 700 to perform any aspect of the point-based mesh generation technology described herein, including according to any of the features of the point identification engine 108, the point-based meshing engine 110, or combinations of both.

For example, execution of the point identification instructions 722 by the processor 710 may cause the computing system 700 to identify a point on a CAD of a CAD object, doing so in any of the ways described herein. Execution of the point-based meshing instructions 724 by the processor 710 may cause the computing system 700 to construct an imprint shape that surrounds the identified point by performing an iterative imprint shape determination process. For a given iteration of the iterative imprint shape determination process, execution of the point-based meshing instructions 724 may cause the computing system to construct a candidate imprint shape for the given iteration, orient the candidate imprint shape along a determined mesh element direction of background mesh elements of the CAD face covered by the candidate imprint shape, and perform an intersection check between the candidate imprint shape and a boundary set for the CAD face. The boundary set can boundaries of the CAD face or boundaries of other imprint shapes for the CAD face.

When the intersection check indicates the candidate imprint shape intersects a boundary in the boundary set for the CAD face, execution of the point-based meshing instructions 724 may cause the computing system 700 to determine a candidate imprint shape from a previous iteration of the iterative imprint shape determination process as the imprint shape that surrounds the identified point. Execution of the point-based meshing instructions 724 may also cause the computing system to mesh the determined imprint shape that surrounds the identified point.

Any additional or alternative point-based meshing features as described herein may be implemented via the point identification instructions 722, point-based meshing instructions 724, or a combination of both.

The systems, methods, devices, and logic described above, including the point identification engine 108 and the point-based meshing engine 110, may be implemented in many different ways in many different combinations of hardware, logic, circuitry, and executable instructions stored on a machine-readable medium. For example, the point identification engine 108, the point-based meshing engine 110, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the point identification engine 108, the point-based meshing engine 110, or combinations thereof.

The processing capability of the systems, devices, and engines described herein, including the point identification engine 108 and the point-based meshing engine 110, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
identifying a point on a computer-aided design (CAD) face of a CAD object;
constructing an imprint shape that surrounds the identified point by performing an iterative imprint shape determination process, including by, for a given iteration of the iterative imprint shape determination process:
constructing a candidate imprint shape for the given iteration;
orienting the candidate imprint shape along a determined mesh element direction of background mesh elements of the CAD face covered by the candidate imprint shape;
performing an intersection check between the candidate imprint shape and a boundary set for the CAD face, wherein the boundary set comprises a boundary of the CAD face; and
when the intersection check indicates the candidate imprint shape intersects a boundary in the boundary set for the CAD face, determining a candidate imprint shape from a previous iteration of the iterative imprint shape determination process as the imprint shape that surrounds the identified point; and
meshing the determined imprint shape that surrounds the identified point.

2. The method of claim 1, wherein constructing the candidate imprint shape for the given iteration comprises expanding the candidate imprint shape of the previous iteration of the iterative imprint shape determination process.

3. The method of claim 1, wherein performing the iterative imprint shape determination process further comprises:
when the intersection check indicates the candidate imprint shape does not intersect any boundary in the boundary set, proceeding to a next iteration of the iterative imprint shape determination process.

4. The method of claim 1, comprising identifying the point as a user-selected point on the CAD face and
meshing the determined imprint shape that surrounds the identified point without further user input.

5. The method of claim 1, comprising identifying the point on the CAD face by:
determining a rectangle with a largest area that fits in the CAD face; and
determining the point as a centroid of the rectangle with the largest area that fits in the CAD face.

6. The method of claim 1, wherein the boundary set further comprises a boundary of a different imprint shape for the CAD face, and comprising performing the intersection check between the candidate imprint shape and the boundary of the different imprint shape for the CAD face.

7. The method of claim 1, wherein performing the intersection check comprises determining whether the candidate imprint shape is within a threshold distance from any boundary in the boundary set.

8. A system comprising:
a processor; and
a non-transitory machine-readable medium comprising instructions that, when executed by the processor, cause a computing system to:
identify a point on a computer-aided design (CAD) face of a CAD object;
construct an imprint shape that surrounds the identified point by performing an iterative imprint shape determination process, including by, for a given iteration of the iterative imprint shape determination process:
constructing a candidate imprint shape for the given iteration;
orienting the candidate imprint shape along a determined mesh element direction of background mesh elements of the CAD face covered by the candidate imprint shape;
performing an intersection check between the candidate imprint shape and a boundary set for the CAD face, wherein the boundary set comprises a boundary of the CAD face; and
when the intersection check indicates the candidate imprint shape intersects a boundary in the boundary set for the CAD face, determining a candidate imprint shape from a previous iteration of the iterative imprint shape determination process as the imprint shape that surrounds the identified point; and
mesh the determined imprint shape that surrounds the identified point.

9. The system of claim 8, wherein the instructions, when executed, cause the computing system to construct the candidate imprint shape for the given iteration by expanding the candidate imprint shape of the previous iteration of the iterative imprint shape determination process.

10. The system of claim 8, wherein the instructions, when executed, cause the computing system to perform the iterative imprint shape determination process further by:
when the intersection check indicates the candidate imprint shape does not intersect any boundary in the boundary set, proceeding to a next iteration of the iterative imprint shape determination process.

11. The system of claim 8, wherein the instructions, when executed, cause the computing system to identify the point as a user-selected point on the CAD face and to mesh the determined imprint shape that surrounds the identified point without further user input.

12. The system of claim 8, wherein the instructions, when executed, cause the computing system to identify the point on the CAD face by:
determining a rectangle with a largest area that fits in the CAD face; and
determining the point as a centroid of the rectangle with the largest area that fits in the CAD face.

13. The system of claim 8, wherein the boundary set further comprises a boundary of a different imprint shape for the CAD face, and wherein the instructions, when executed, cause the computing system to perform the intersection check between the candidate imprint shape and the boundary of the different imprint shape for the CAD face.

14. The system of claim 8, wherein the instructions, when executed, cause the computing system to perform the intersection check by determining whether the candidate imprint shape is within a threshold distance from any boundary in the boundary set.

15. A non-transitory machine-readable medium comprising instructions that, when executed by a processor, cause a computing system to:
identify a point on a computer-aided design (CAD) face of a CAD object;
construct an imprint shape that surrounds the identified point by performing an iterative imprint shape determination process, including by, for a given iteration of the iterative imprint shape determination process:
constructing a candidate imprint shape for the given iteration;
orienting the candidate imprint shape along a determined mesh element direction of background mesh elements of the CAD face covered by the candidate imprint shape;
performing an intersection check between the candidate imprint shape and a boundary set for the CAD face, wherein the boundary set comprises a boundary of the CAD face; and
when the intersection check indicates the candidate imprint shape intersects a boundary in the boundary set for the CAD face, determining a candidate imprint shape from a previous iteration of the iterative imprint shape determination process as the imprint shape that surrounds the identified point; and
mesh the determined imprint shape that surrounds the identified point.

16. The non-transitory machine-readable medium of claim 15, wherein the instructions, when executed, cause the computing system to construct the candidate imprint shape for the given iteration by expanding the candidate imprint shape of the previous iteration of the iterative imprint shape determination process.

17. The non-transitory machine-readable medium of claim 15, wherein the instructions, when executed, cause the computing system to perform the iterative imprint shape determination process further by:
when the intersection check indicates the candidate imprint shape does not intersect any boundary in the boundary set, proceeding to a next iteration of the iterative imprint shape determination process.

18. The non-transitory machine-readable medium of claim 15, wherein the instructions, when executed, cause the computing system to identify the point on the CAD face by:
determining a rectangle with a largest area that fits in the CAD face; and
determining the point as a centroid of the rectangle with the largest area that fits in the CAD face.

19. The non-transitory machine-readable medium of claim 15, wherein the boundary set further comprises a boundary of a different imprint shape for the CAD face and wherein the instructions, when executed, cause the computing system to perform the intersection check between the candidate imprint shape and the boundary of the different imprint shape for the CAD face.

20. The non-transitory machine-readable medium of claim 15, wherein the instructions, when executed, cause the computing system to perform the intersection check by determining whether the candidate imprint shape is within a threshold distance from any boundary in the boundary set.
